(19) United States
(12) Patent Application Publication
(10) Pub. No.: US 2026/0222886 A1
(43) Pub. Date: Jul. 30, 2026

(54) METHOD AND APPARATUS FOR PERFORMANCE MONITORING

(71) Applicant: 1FINITY Inc., Kawasaki-shi (JP)

(72) Inventors: Guotong WANG, Beijing (CN); Xin WANG, Beijing (CN); Tingting GENG, Beijing (CN); Yujia SHAN, Beijing (CN); Liqiang JIN, Beijing (CN); Gang SUN, Beijing (CN); Qun ZHANG, Beijing (CN)

(73) Assignee: 1FINITY Inc., Kawasaki-shi (JP)

(21) Appl. No.: 19/577,852

(22) Filed: Mar. 25, 2026

Related U.S. Application Data
(63) Continuation of application No. PCT/CN2023/122080, filed on Sep. 27, 2023.

(51) Int. Cl. H04W 24/10

(52) U.S. Cl. CPC H04W 24/10

(57) ABSTRACT

An apparatus for performance monitoring, includes: a receiver configured to receive a first configuration and a second configuration transmitted by a network device; wherein the first configuration at least comprises one or more performance metrics and the second configuration at least comprises a reporting configuration; processor circuitry configured to, according to the first configuration, monitor performance of a functionality of AI/ML (Artificial Intelligence/Machine Learning); and a transmitter configured to transmit performance information corresponding to the functionality to the network device according to the reporting configuration.

### CROSS-REFERENCE TO RELATED APPLICATION

This application is a continuation application under 35 U.S.C. 111(a) of International Patent Application PCT/CN2023/122080 filed on September 27, 2023, and designated the U.S., the entire contents of which are incorporated herein by reference.

### TECHNICAL FIELD

Embodiments of the present application relate to the field of communications technologies.

### BACKGROUND

In NR Rel-18, research has been conducted on Artificial Intelligence (AI)/Machine Learning (ML) for an air interface. AI/ML may be used for the following use cases: Channel State Information (CSI) feedback enhancement, beam management, and positioning enhancement. The CSI feedback enhancement may include CSI prediction and CSI compression; the beam management may include spatial beam prediction and temporal beam prediction; and the positioning enhancement may include direct positioning and AI/ML assisted positioning.

In some sub use cases, a bilateral model may be used, where an AI/ML model operates on both a terminal equipment side and a network device side. For example, CSI compression may serve as a representative use case of the bilateral model. In some other sub use cases, a unilateral model may be used, where the AI/ML model operates on either a terminal equipment side or a network device side.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

The inventor finds that, for an AI/ML model located on a terminal equipment side, performance should be monitored by the terminal equipment. However, there is currently no clear and accurate solution as to how to perform monitoring.

To address at least one of the above problems, embodiments of the present application provide a method and an apparatus for performance monitoring.

According to an aspect of embodiments of the present application, there is provided with a method for performance monitoring, including:

receiving, by a terminal equipment, a first configuration transmitted by a network device;

based on the first configuration, monitoring performance of an AI/ML model of which a functionality is enabled or activated, the functionality including a feature or a feature group enabled by a configuration indicated by capability of a terminal equipment; and

transmitting performance information corresponding to the functionality to the network device.

According to another aspect of the embodiments of the present application, there is provided with an apparatus for performance monitoring, including:

a receiving unit configured to receive a first configuration transmitted by a network device;

a monitoring unit configured to, based on the first configuration, monitor performance of an AI/ML model of which a functionality is enabled or activated, the functionality including a feature or a feature group enabled by a configuration indicated by capability of a terminal equipment; and

a transmitting unit configured to transmit performance information corresponding to the functionality to the network device.

According to another aspect of the embodiments of the present application, there is provided with a method for performance monitoring, including:

transmitting, by a network device, a first configuration to a terminal equipment; wherein the terminal equipment is configured to, based on the first configuration, monitor performance of an AI/ML model of which a functionality is enabled or activated, the functionality including a feature or a feature group enabled by a configuration indicated by capability of a terminal equipment; and

receiving, by the network device, performance information corresponding to the functionality transmitted by the terminal equipment.

According to another aspect of the embodiments of the present application, there is provided with an apparatus for performance monitoring, including:

a transmitting unit configured to transmit a first configuration to a terminal equipment; wherein the terminal equipment is configured to, based on the first configuration, monitor performance of an AI/ML model of which a functionality is enabled or activated, the functionality including a feature or a feature group enabled by a configuration indicated by capability of a terminal equipment; and

a receiving unit configured to receive performance information corresponding to the functionality transmitted by the terminal equipment.

According to another aspect of the embodiments of the present application, there is provided with a communication system, including:

a network device configured to transmit a first configuration to a terminal equipment;

the terminal equipment configured to, based on the first configuration, monitor performance of an AI/ML model of which a functionality is enabled or activated, the functionality including a feature or a feature group enabled by a configuration indicated by capability of a terminal equipment; and transmit performance information corresponding to the functionality to the network device.

One of the beneficial effects of the embodiments of the present application is that the AI/ML model on the terminal equipment side is able to be monitored accurately, thereby improving accuracy and reliability of AI/ML.

With reference to the specification and drawings below, a specific embodiment of the present application is disclosed in detail, which specifies the manner in which the principle of the present application can be adopted. It should be understood that, the scope of the embodiments of the present application is not limited. Within the scope of the spirit and clause of the appended claims, the embodiments of the present application include many variations, modifications and equivalents.

The features described and/or shown for one embodiment can be used in one or more other embodiments in the same or similar manner, can be combined with the features in other embodiments or replace the features in other embodiments.

It should be emphasized that, the term "include/comprise" refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

FIG. 1 is a schematic diagram of a communication system in embodiments of the present application;

FIG. 2 is a schematic diagram of a method for performance monitoring in the embodiments of the present application;

FIG. 3 is a schematic diagram of performance monitoring for functionalities in the embodiments of the present application;

FIG. 4 is an exemplary diagram of performance information reporting in the embodiments of the present application;

FIG. 5 is another exemplary diagram of performance information reporting in the embodiments of the present application;

FIG. 6 is another exemplary diagram of performance information reporting in the embodiments of the present application;

FIG. 7 is a schematic diagram of a method for performance monitoring in the embodiments of the present application;

FIG. 8 is a schematic diagram of an apparatus for performance monitoring in the embodiments of the present application;

FIG. 9 is a schematic diagram of an apparatus for performance monitoring in the embodiments of the present application;

FIG. 10 is a schematic diagram of a network device in the embodiment of the present application;

FIG. 11 is a schematic diagram of a terminal equipment in the embodiment of the present application.

### DETAILED DESCRIPTION

With reference to the drawings, the foregoing and other features of the present application will become apparent through the following specification. The specification and the accompanying drawings specifically disclose the particular embodiment of the present application, showing part of the embodiment in which the principle of the present application can be adopted, it should be understood that the present application is not limited to the described embodiment, on the contrary, the present application includes all modifications, variations and equivalents that fall within the scope of the appended claims.

In embodiments of the present application, the terms "first", "second", etc., are used to distinguish different elements by their appellation, but do not indicate the spatial arrangement or chronological order of these elements, etc., and these elements shall not be limited by the terms. The term "and/or" includes any and all combinations of one or more of the terms listed in association with the term. The terms "contain", "include", "have", etc., refer to the presence of the stated feature, element, component or assembly, but do not exclude the presence or addition of one or more other features, elements, components or assemblies.

In embodiments of the present application, the singular forms "one", "the", etc., including the plural forms, shall be broadly understood as "a sort of" or "a kind of" and not limited to the meaning of "one"; furthermore, the term "said" shall be understood to include both the singular form and the plural form, unless it is expressly indicated otherwise in the context. In addition, the term "according to" should be understood to mean "at least partially according to ...", and the term "based on" should be understood to mean "based at least partially on ...", unless it is expressly indicated otherwise in the context.

In embodiments of the present application, the term "communications network" or "wireless communications network" may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system can be carried out according to the communication protocol of any stage, for example, including but not being limited to 1G (generation), 2G, 2.5G, 2.75G, 3G, 4G, 4.5G and 5G, New Radio (NR), future 6G and etc., and/or other communication protocols currently known or to be developed in the future.

In embodiments of the present application, the term "network device" refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), an IAB donor, etc., and may also include a remote radio head (RRH), a remote radio unit (RRU), a relay, or a low-power node (such as femto, pico, etc.). And the term "base station" may include some or all of their functions, with each base station providing communication coverage to a specific geographic area. The term "cell" can refer to a base station and/or its coverage area, depending on the context in which the term is used.

In embodiments of the present application, the term "user equipment" (UE) or "terminal equipment or terminal device" (TE) refers, for example, to a device that is connected to the communication network through the network device and receives network services. The terminal equipment can be fixed or movable, and can also be called a mobile station (MS), a terminal, a subscriber station (SS), an access terminal (AT), a station, etc.

The terminal equipment may include but is not limited to: a cellular phone, a personal digital assistant (PDA), a wireless modems, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

In addition, the term "network side" or "network device side" refers to the side of the network, which may be a base station or may include one or more network devices as described above. The term "user side" or "terminal side" or "terminal equipment side" refers to the side of the user or terminal, which may be a UE or may include one or more terminal equipments as described above. Without specifically indicated, "device" can refer to a network device or a terminal equipment.

Hereinafter the scenarios of in the embodiments of the present application are illustrated by examples, but which is not limited in the present application.

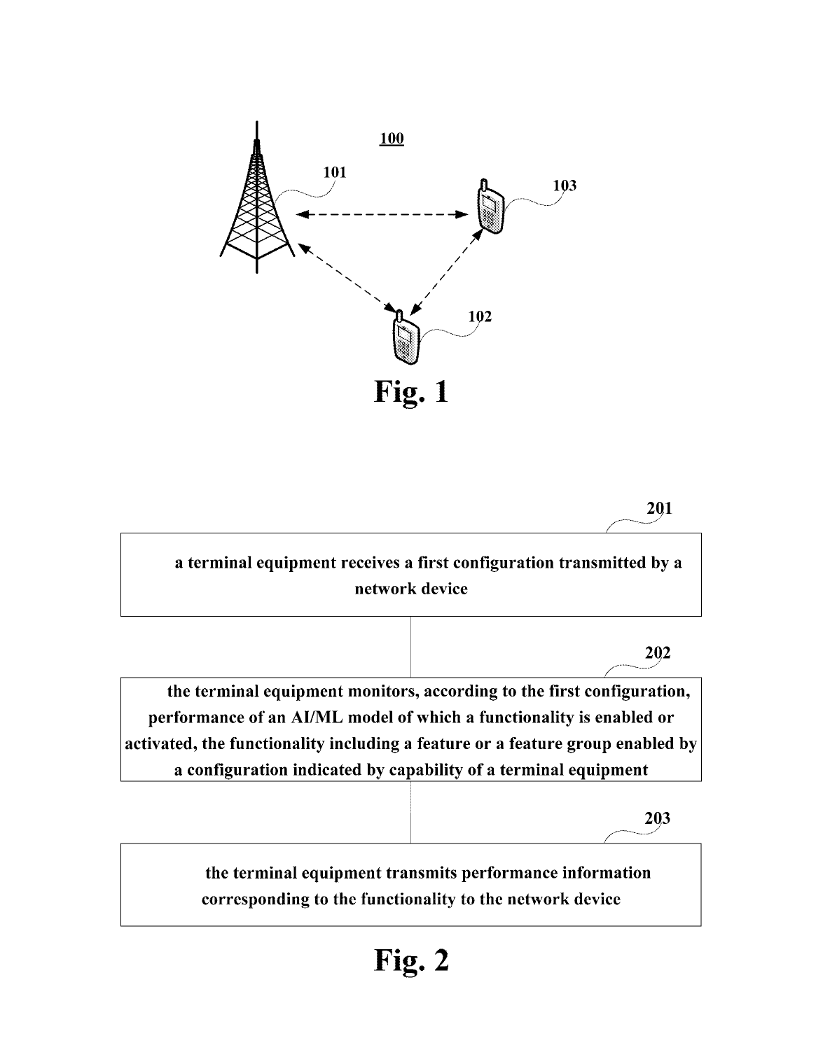

FIG. 1 is a schematic diagram of a communication system in embodiments of the present application, illustrating the case of the terminal equipment and the network device as examples. As shown in FIG. 1, a communication system 100 may include a network device 101 and terminal equipments 102 and 103. For simplicity, FIG. 1 illustrates only two terminal equipments and one network device as examples, but which is not limited in the embodiments of the present application.

In the embodiments of the present application, existing services or services that can be implemented in the future may be transmitted between the network device 101 and the terminal equipments 102, 103. For example, these services may include, but are not limited to, enhanced Mobile Broadband (eMBB), massive Machine Type Communication (mMTC), and Ultra-Reliable and Low-Latency Communication (URLLC), and etc.

It is worth noting that FIG. 1 shows that two terminal equipments 102 and 103 are within the coverage of the network equipment 101, but which is not limited in the present application. Both of the two terminal equipments 102 and 103 may not be within a coverage of the network device 101, or one terminal equipment 102 is within the coverage of the network device 101 and the other terminal equipment 103 is outside the coverage of the network device 101.

In the embodiments of the present application, the higher layer signaling may be, for example, Radio Resource Control (RRC) signaling; for example, it is called an RRC message, e.g., including MIB, system information, and a dedicated RRC message; or it is referred to as RRC information element (RRC IE). For example, the higher layer signaling may also be Medium Access Control (MAC) signaling; or is also called MAC control element (MAC CE). However, the present application is not limited to this.

In the embodiments of the present application, one or more AI/ML models may be configured and run in the network device and/or the terminal equipment. The AI/ML models may be used in various signal processing functions of wireless communication, such as CSI prediction, CSI compression, beam prediction and positioning management, etc. The present application is not limited to this.

### Embodiments of a First Aspect

The embodiments of the present application provide a method for performance monitoring. FIG. 2 is a schematic diagram of a method for performance monitoring in the embodiments of the present application. As shown in FIG. 2, the method includes:

201: a terminal equipment receives a first configuration transmitted by a network device;

202: the terminal equipment monitors, according to the first configuration, performance of an AI/ML model of which a functionality is enabled or activated, the functionality including a feature or a feature group enabled by a configuration indicated by capability of a terminal equipment; and

203: the terminal equipment transmits performance information corresponding to the functionality to the network device.

It is worth noting that FIG. 2 above only schematically illustrates the embodiments of the present application, but the present application is not limited to this. For example, the order of execution between operations may be adjusted appropriately, and some other operations may be added or one or more operations may be removed. Those skilled in the art may make appropriate variations in accordance with the above contents, and which is not limited to the disclosure of FIG. 2 above.

In some embodiments, functionality refers to an AI/ML feature/feature group enabled by a configuration, wherein the configuration is supported based on a condition indicated by capability of UE.

For example, an AL/ML functionality may be one or more functionalities, or one or more logic models, or one or more sub functionalities, or one or more features, or one or more feature groups.

For another example, the functionality may refer to using AI/ML for spatial beam prediction, or using AI/ML for temporal beam prediction, or using AI/ML for CSI prediction, or using AI/ML for direct positioning, or using AI/ML assisted positioning, etc.

In some embodiments, the AI/ML model is located on a terminal equipment side. The performance of the AI/ML model is monitored by a terminal equipment, and the terminal equipment may report performance information to a network device. The network device judges (determines or detects) whether the AI/ML performance corresponding to one or some functionalities of the AI/ML model is operating normally.

In some embodiments, the first configuration includes at least one of the following: a performance metric, a parameter for controlling monitoring, or a reference signal configuration. The present application is not limited to this, and the first configuration may include other information/parameters/conditions/resource configuration, etc. for performance monitoring. In addition, the first configuration may include any one of the above information, or any combination of two or more of the above information.

For example, an AI/ML functionality is on a UE side. After enabling or activating the AI/ML functionality, the UE monitors an AI/ML operation based on the first configuration from the network side. The first configuration may include a performance metric, a parameter for controlling monitoring (e.g., parameters for event triggering, parameters for activation/deactivation triggering, such as counters, timers, thresholds, conditions), CSI-RS resource configuration, etc. The performance metric may include AI/ML output performance, data input/output distribution, measurement statistics compared to input statistics, etc.

In some embodiments, the terminal equipment receives a second configuration transmitted by the network device; and the terminal equipment transmits performance information corresponding to the functionality to the network device based on the second configuration.

In some embodiments, the second configuration includes at least one of the following: a reporting configuration, an uplink resource for transmitting the performance information, or a manner for reporting the performance information; the manner includes periodic reporting, semi-persistent reporting, or aperiodic reporting; the performance information includes at least one of the following: a performance metric, input data drift, or output data drift. The present application is not limited to this. In addition, the second configuration or performance information may include any one of the above information, or any combination of two or more of the above information.

In some embodiments, the functionality is one or more, the terminal equipment performs AI/ML performance monitoring for each functionality separately, and the network device determines whether the functionality fails or whether the functionality is deactivated according to the performance information.

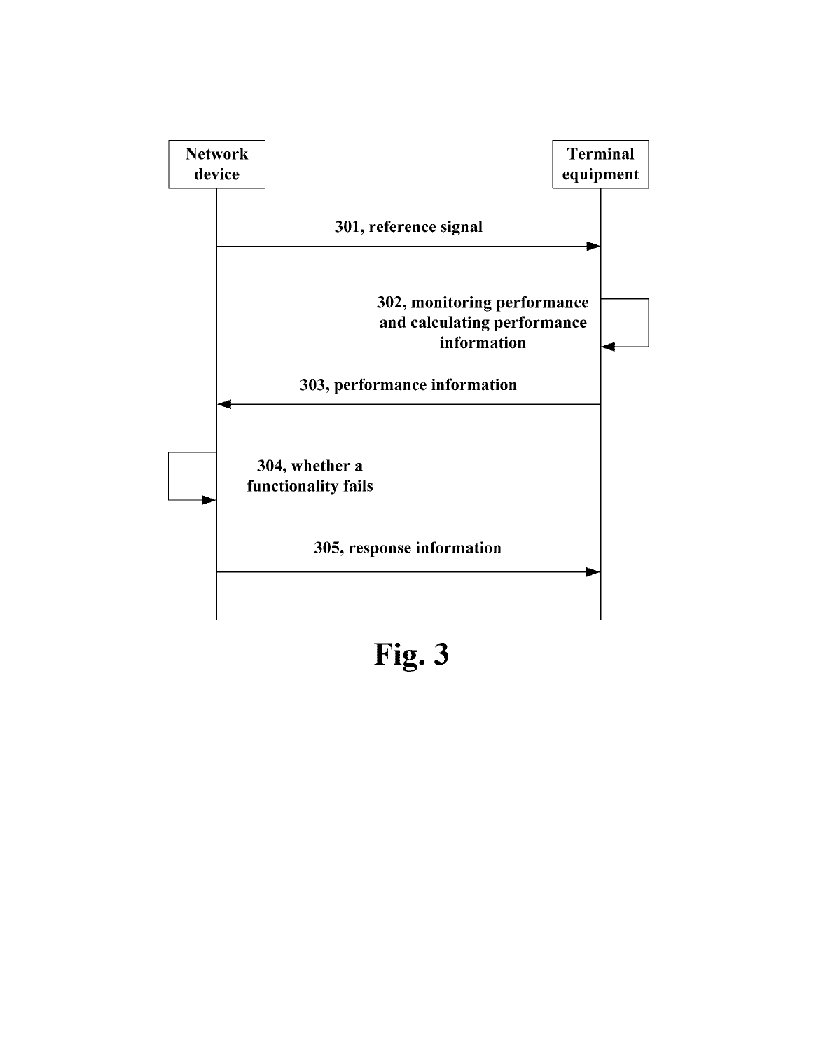

FIG. 3 is a schematic diagram of performance monitoring for functionalities in the embodiments of the present application. As shown in FIG. 3, the process includes:

301: the terminal equipment receives a reference signal for the AI/ML performance monitoring, transmitted by the network device;

302: the terminal equipment monitors the AI/ML performance corresponding to the functionality based on the reference signal and calculates the performance information.

For example, the UE monitors the AI/ML performance of a certain functionality and detects whether the performance has degraded, and the UE is able to calculate performance information.

303: the terminal equipment transmits performance information corresponding to one or more functionalities to the network device.

For example, the performance information transmitted from the UE to the base station may be used for one functionality or used for more functionalities (e.g., for N functionalities, where the value of N may be configured or predefined).

304: the network device determines whether the corresponding functionality fails or whether the functionality is deactivated according to the performance information; and

305: the terminal equipment receives response information fed back from the network device, the response information including at least one of the following: functionality activation information, functionality deactivation information, functionality fallback information, functionality switching information or reconfiguration information. The present application is not limited to this. In addition, the response information may include any one of the above information, or any combination of two or more of the above information.

It is worth noting that FIG. 3 above only schematically illustrates the embodiments of the present application, but the present application is not limited to this. For example, the order of execution between operations may be adjusted appropriately, and some other operations may be added or one or more operations may be removed. Those skilled in the art may make appropriate variations in accordance with the above contents, and which is not limited to the disclosure of FIG. 3 above.

In some embodiments, the reference signal for the AI/ML performance monitoring is different from a reference signal for measurement or inference; or the reference signal for the AI/ML performance monitoring is the same as the reference signal for measurement or inference; or the reference signal for the AI/ML performance monitoring is at least a part of the reference signal for measurement or inference.

In some embodiments, the reference signal is a periodic signal for AI/ML performance monitoring for one functionality. For example, the reference signal is a periodic CSI-RS.

In some embodiments, the reference signal for AI/ML performance monitoring for one functionality is configured by radio resource control (RRC), or the reference signal for AI/ML performance monitoring for one functionality is determined by the terminal equipment.

For example, a base station may configure a periodic reference signal for performance monitoring for one functionality. For example, whether the reference signal is used for monitoring, measurement or prediction may be explicitly identified through RRC configuration. For another example, whether the reference signal is used for monitoring, measurement or prediction may also be configured not explicitly. The UE may decide on its own whether one reference signal is used for monitoring, measurement or prediction.

For another example, if there is no reference signal configured for performance monitoring, the reference signal used by the UE for measurement and/or inference may be used for performance monitoring of one or more functionalities.

For another example, the reference signal may be semi-persistent or aperiodic.

In some embodiments, the performance information transmitted by the terminal equipment to the network device is for one or more functionalities.

In some embodiments, the performance information is periodically reported; periodic reference signals are configured for performing the monitoring, and uplink resources are configured for performing reporting of the performance information; or the performance information is reported by using two-step random access.

For example, the performance information may be physical layer (layer 1) information. The performance information may be transmitted via PUCCH or PUSCH. Alternatively, the performance information may be transmitted via two-step RACH. For example, the UE may transmit a preamble and PUSCH to the base station, the performance information is included in PUSCH, and the UE receives RA response transmitted by the base station.

For another example, the terminal equipment may periodically report the performance information. The base station may configure periodic reference signals for performance monitoring and corresponding uplink resources (PUCCH or PUSCH) for the terminal equipment, so that the terminal equipment periodically transmits the performance information.

In some embodiments, the performance information is semi-persistently reported; periodic or semi-persistent reference signals are configured for performing the monitoring, and uplink resources are configured for performing reporting of the performance information; and the semi-persistent reporting is activated/deactivated by MAC CE or DCI.

For example, the terminal equipment may semi-persistently report the performance information. The base station may configure periodic/semi-persistent reference signals for performance monitoring and corresponding uplink resources (PUCCH or PUSCH) for the terminal equipment, so that the terminal equipment transmits the performance information.

For semi-persistent reporting of the performance information, the base station may transmit a command to activate/deactivate the semi-persistent reporting. The command may be MAC CE or DCI. For example, the MAC CE or DCI may be newly defined. For another example, existing MAC CE or DCI may be reused. For another example, if DCI is used to activate/deactivate semi-persistent reporting of the performance information, a new RNTI may be introduced.

In some embodiments, the performance information is aperiodically reported; and the aperiodic reporting is triggered by DCI.

For example, the terminal equipment may aperiodically report the performance information. The base station may configure periodic/semi-persistent/aperiodic reference signals for performance monitoring for the terminal equipment. The performance information may be transmitted via PUSCH or PUCCH. The base station may trigger aperiodic reporting of the performance information via DCI. For example, a new DCI field may be introduced, or an existing DCI field may be reused.

In some embodiments, the first configuration for performance monitoring and/or the second configuration for performance information reporting are different from configuration for AI/ML reporting, or the first configuration for performance monitoring and/or the second configuration for performance information reporting are the same as the configuration for AI/ML reporting; or the first configuration for performance monitoring and/or the second configuration for performance information reporting are at least a part of the configuration for AI/ML reporting;

the AI/ML reporting includes at least one of the following: CSI reporting, beam reporting, or positioning information reporting.

For example, the configuration for performance monitoring and performance information reporting may be separated from the configuration for AI/ML reporting, wherein the AI/ML reporting may be CSI reporting, beam reporting and positioning reporting, etc. For example, new CSI-ReportConfig and/or CSI-ResourceConfig and/or CSI-RS Resource set may be introduced for performance monitoring and/or performance information reporting of one or more functionalities. For another example, a positioning reference signal (PRS) or a PRS resource set may be configured in CSI-ResourceConfig.

For another example, the configuration for performance monitoring and performance information reporting may use the configuration for AI/ML reporting, or use a part of the configuration for AI/ML reporting, wherein the AI/ML reporting may be CSI reporting, beam reporting or positioning reporting, etc. For example, existing CSI-ReportConfig and/or CSI-ResourceConfig and/or CSI-RS Resource set may be used for performance monitoring and/or performance information reporting of one or more functionalities.

For another example, for different functionalities, the first configuration for performance monitoring and/or the second configuration for performance information reporting are different; or for different functionalities, the first configuration for performance monitoring and/or the second configuration for performance information reporting are the same.

For another example, one first configuration for performance monitoring and/or one second configuration for performance information reporting are applied to one functionality, or one first configuration for performance monitoring and/or one second configuration for performance information reporting are applied to multiple functionalities.

In some embodiments, a manner for performance information reporting is different from a manner for AI/ML reporting, or the manner for performance information reporting is the same as the manner for AI/ML reporting; the manner includes periodic reporting, aperiodic reporting or semi-persistent reporting; the AI/ML reporting includes at least one of the following: CSI reporting, beam reporting, or positioning information reporting.

For example, a time-domain behavior of the performance information reporting (periodic/semi-persistent/aperiodic) may be the same as a time-domain behavior of the AI/ML reporting. Alternatively, the time-domain behavior of the performance information reporting (periodic/semi-persistent/aperiodic) may be different from the time-domain behavior of the AI/ML reporting.

In some embodiments, for different functionalities, the manner for performance information reporting is different from the manner for AI/ML reporting, or for different functionalities, the manner for performance information reporting is the same as the manner for AI/ML reporting; the manner includes periodic reporting, aperiodic reporting or semi-persistent reporting; the AI/ML reporting includes at least one of the following: CSI reporting, beam reporting, or positioning information reporting.

For example, for different functionalities, the time-domain behavior of the performance information reporting (periodic/semi-persistent/aperiodic) may be the same. Alternatively, for different functionalities, the time-domain behavior of the performance information reporting (periodic/semi-persistent/aperiodic) may be different.

In some embodiments, the performance information is reported via MAC CE; the MAC CE includes performance information for one or more functionalities; or the performance information is reported via PUCCH or MAC CE; the MAC CE includes performance information for one or more functionalities; or the performance information is reported via an RRC message; the RRC message includes performance information for one or more functionalities.

For example, the UE may initiate performance information reporting of one or more functionalities to the base station to assist the base station in making a decision on whether or not to activate/deactivate the one or more functionalities. For example, the performance information may be contained in a new MAC CE, and the MAC CE may contain performance information for one or more functionalities.

In some embodiments, the performance information is periodically transmitted according to a timer and aperiodically transmitted based on a condition or event; or the performance information is periodically transmitted according to the timer; or the performance information is aperiodically transmitted based on the condition or event.

For example, the performance information may be transmitted to the network side periodically and also based on some predefined conditions/events. For example, the UE periodically detects the AI/ML performance of one or more functionalities. If the performance metrics of at least one functionality is lower than a certain threshold, performance information reporting should be triggered, such as transmitting MAC CE.

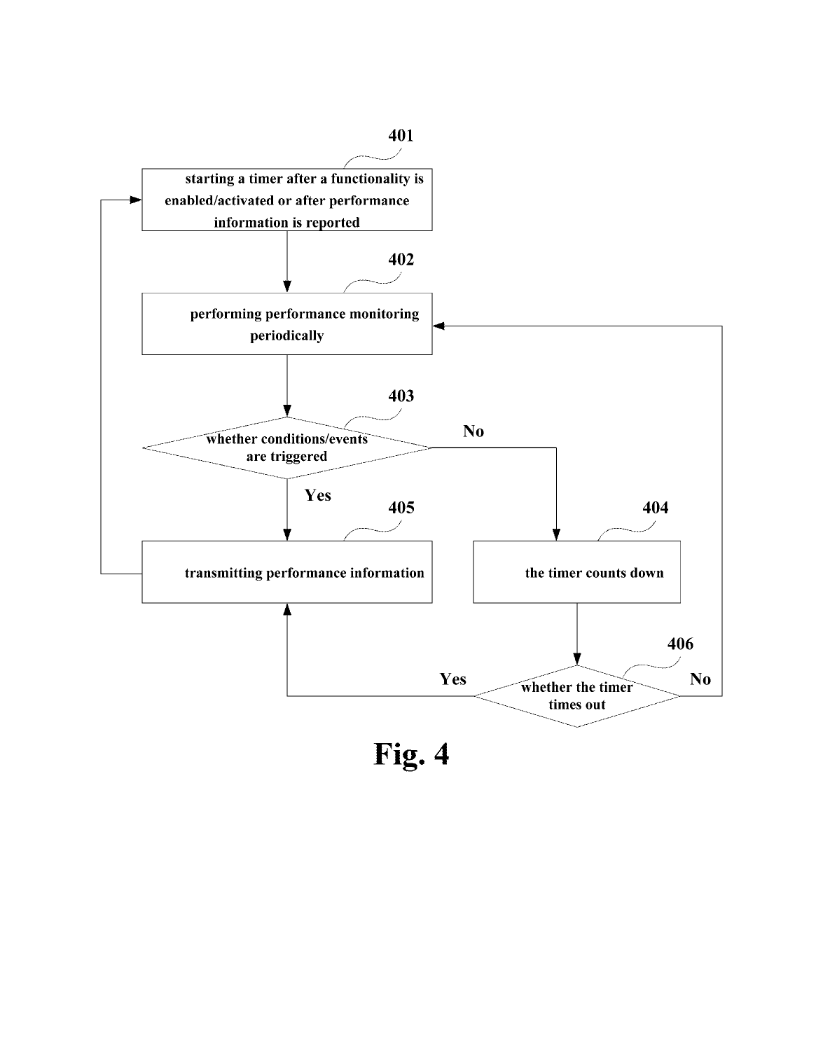

FIG. 4 is an exemplary diagram of performance information reporting in the embodiments of the present application. As shown in FIG. 4, the UE may maintain a timer. After the functionality is enabled/activated (or after the performance information is reported), the UE starts the timer (see 401 in FIG. 4). The UE periodically performs performance monitoring (see 402 in FIG. 4) and may determine whether the conditions/events for performance information reporting are triggered (see 403 in FIG. 4).

If performance information reporting is not triggered, the timer counts down (see 404 in FIG. 4). If performance information reporting is triggered, the UE reports the performance information via MAC CE (see 405 in FIG. 4), the MAC CE including performance information corresponding to one or more functionalities. The UE further determines whether the timer times out (see 406 in FIG. 4). If the timer times out, the UE transmits performance information, and after transmitting the performance information, the UE restarts the timer.

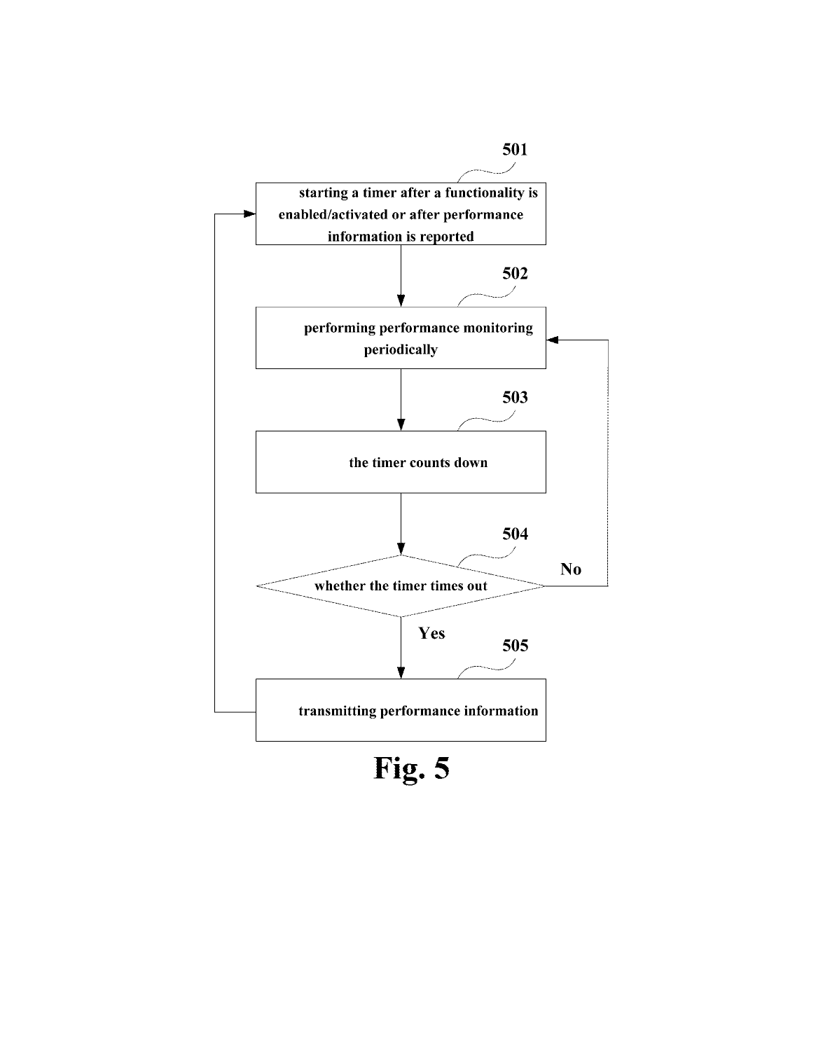

FIG. 5 is another exemplary diagram of performance information reporting in the embodiments of the present application. As shown in FIG. 5, the UE may maintain the timer. After the functionality is enabled/activated (or after the performance information is reported), the UE starts the timer (see 501 in FIG. 5). The UE periodically performs performance monitoring (see 502 in FIG. 4), and the timer counts down (see 503 in FIG. 5). The UE further determines whether the timer times out (see 504 in FIG. 5). If the timer times out, the UE reports the performance information via MAC CE (see 505 in FIG. 5), the MAC CE including performance information corresponding to one or more functionalities. After transmitting the performance information, the UE restarts the timer.

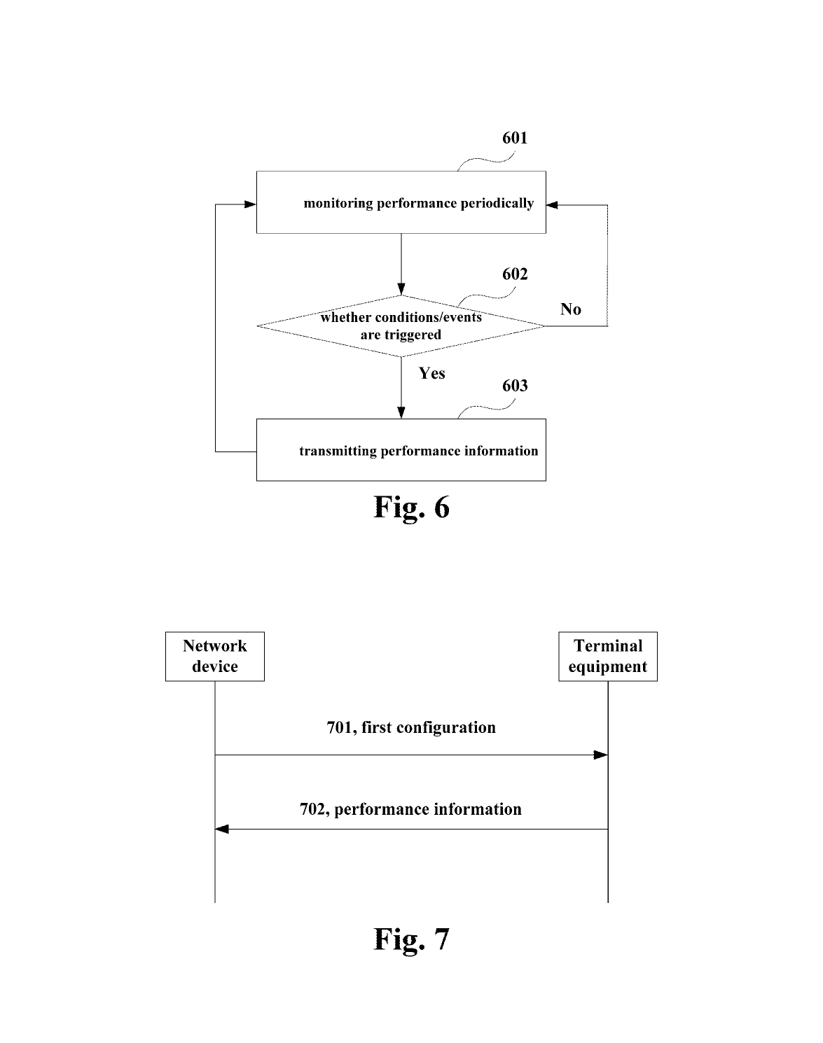

FIG. 6 is another exemplary diagram of performance information reporting in the embodiments of the present application. As shown in FIG. 6, after the functionality is enabled/activated, the UE periodically performs performance monitoring (see 601 in FIG. 6) and may determine whether the conditions/events for performance information reporting are triggered (see 602 in FIG. 6).

If performance information reporting is not triggered, the UE continues to perform performance monitoring. If performance information reporting is triggered, the UE reports the performance information via MAC CE (see 603 in FIG. 6), the MAC CE including performance information corresponding to one or more functionalities.

Hereinbefore performance information reporting is exemplarily illustrated, but the present application is not limited to this.

In some embodiments, performance information of one or more functionalities may be transmitted by using at least one of the following: an uplink control channel resource, MAC CE, two-step random access, a radio resource control (RRC) message.

For example, the UE may be configured with resources similar to PUCCH SR for performance information reporting. The performance information may be contained in a new MAC CE, and the MAC CE may contain performance information for one or more functionalities. For example, if the performance metrics of at least one functionality is lower than a certain threshold, the UE may transmit resources similar to PUCCH SR to the base station. Upon reception of the resources similar to PUCCH SR, the base station transmits DCI containing an uplink grant for PUSCH transmission, and the UE transmits MAC CE to the base station based on the uplink grant.

For another example, the performance information may be included in the RRC message. The RRC message may contain performance information for one or more functionalities. The performance information reporting may be triggered based on some predefined conditions/events. For example, if the performance metrics of at least one functionality is lower than a certain threshold, the performance information reporting is triggered and the UE transmits the RRC message. Alternatively, the UE may also periodically transmit the RRC message. For example, the UE maintains the timer, and the UE transmits the RRC message after the timer times out.

For another example, the RRC message may be transmitted not only periodically but also based on some predefined conditions/events. For example, if the performance metrics of at least one functionality is lower than a certain threshold, the UE transmits the RRC message. In addition, the UE may maintain the timer. After the functionality is enabled/activated, the UE starts the timer. If the timer times out, the UE transmits the RRC message. After transmitting the performance information (triggered by an event or when the timer times out), the UE restarts the timer.

The embodiments above only schematically illustrate the present application, but the present application is not limited to this, and appropriate variations can also be made on the basis of the above embodiments. For example, the above embodiments may be used separately, or one or more of the above embodiments may be combined.

As can be seen from the above embodiments of the present application, the AI/ML model on the terminal equipment side is able to be monitored accurately, thereby improving the accuracy and reliability of AI/ML.

### Embodiments of a Second Aspect

The embodiments of the present application provide a method for performance monitoring, which is explained from a network device side. The embodiments of the second aspect is able to be combined with the embodiments of the first aspect, and the same content as the embodiments of the first aspect will not be repeated.

FIG. 7 is a schematic diagram of a method for performance monitoring in the embodiments of the present application. As shown in FIG. 7, the method includes:

701: a network device transmits a first configuration to a terminal equipment; wherein the terminal equipment is configured to, based on the first configuration, monitor performance of an AI/ML model of which a functionality is enabled or activated, the functionality including a feature or a feature group enabled by a configuration indicated by capability of a terminal equipment; and

702: the network device receives performance information corresponding to the functionality transmitted by the terminal equipment.

It is worth noting that FIG. 7 above only schematically illustrates the embodiment of the present application, but the present application is not limited to this. For example, the order of execution between operations may be adjusted appropriately, and some other operations may be added or one or more operations may be removed. Those skilled in the art may make appropriate variations in accordance with the above contents, and which is not limited to the disclosure of FIG. 7 above.

The embodiments above only schematically illustrate the present application, but the present application is not limited to this, and appropriate variations can also be made on the basis of the above embodiments. For example, the above embodiments may be used separately, or one or more of the above embodiments may be combined.

As can be seen from the above embodiments of the present application, the AI/ML model on the terminal equipment side is able to be monitored accurately, thereby improving the accuracy and reliability of AI/ML.

### Embodiments of a Third Aspect

The embodiments of the present application provide an apparatus for performance monitoring. The apparatus may be, for example, a terminal equipment, or one or more parts or components configured in the terminal equipment, and the same content as the embodiments of the first to third aspects will not be repeated.

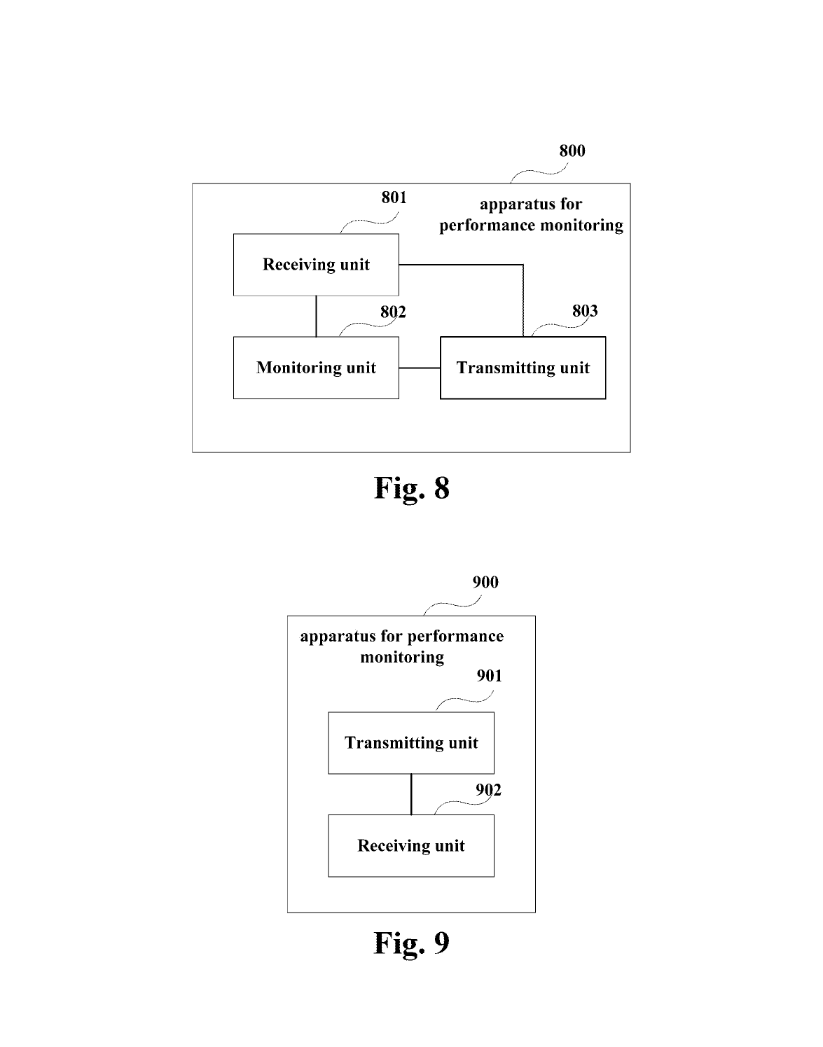

FIG. 8 is a schematic diagram of an apparatus for performance monitoring in the embodiments of the present application. As shown in FIG. 8, an apparatus for performance monitoring 800 includes:

a receiving unit 801 configured to receive a first configuration transmitted by a network device;

a monitoring unit 802 configured to, based on the first configuration, monitor performance of an AI/ML model of which a functionality is enabled or activated, the functionality including a feature or a feature group enabled by a configuration indicated by capability of a terminal equipment; and

a transmitting unit 803 configured to transmit performance information corresponding to the functionality to the network device.

In some embodiments, the AI/ML model is located on a terminal equipment side.

In some embodiments, the first configuration includes at least one of the following: a performance metric, a parameter for controlling monitoring, or a reference signal configuration.

In some embodiments, the receiving unit 801 is further configured to receive a second configuration transmitted by the network device; the transmitting unit 803 is configured to transmit the performance information corresponding to the functionality to the network device according to the second configuration.

In some embodiments, the second configuration includes at least one of the following: a reporting configuration, an uplink resource for transmitting the performance information, or a manner for reporting the performance information; the manner includes periodic reporting, semi-persistent reporting, or aperiodic reporting; the performance information includes at least one of the following: a performance metric, input data drift, or output data drift.

In some embodiments, the functionality is one or more, the terminal equipment performs AI/ML performance monitoring for each functionality separately, and the network device determines whether the functionality fails or whether the functionality is deactivated according to the performance information.

In some embodiments, the receiving unit 801 receives a reference signal for the AI/ML performance monitoring, transmitted by the network device; and the monitoring unit 802 monitors the AI/ML performance corresponding to the functionality according to the reference signal and calculates the performance information .

In some embodiments, the receiving unit 801 is further configured to receive response information fed back from the network device based on indication information, the response information including at least one of the following: functionality activation information, functionality deactivation information, functionality fallback information, functionality switching information or reconfiguration information.

In some embodiments, the reference signal for the AI/ML performance monitoring is different from the reference signal for measurement or inference.

In some embodiments, the reference signal for the AI/ML performance monitoring is the same as the reference signal for measurement or inference.

In some embodiments, the reference signal for the AI/ML performance monitoring is at least a part of the reference signal for measurement or inference.

In some embodiments, the performance information transmitted by the terminal equipment to the network device is for one or more functionalities.

In some embodiments, the performance information is periodically reported; a periodic reference signal is configured for performing the monitoring, and an uplink resource is configured for performing reporting of the performance information; or the performance information is reported by using two-step random access.

In some embodiments, the performance information is semi-persistently reported; a periodic or semi-persistent reference signal is configured for performing the monitoring, and an uplink resource is configured for performing reporting of the performance information; and the semi-persistent reporting is activated/deactivated by MAC CE or DCI.

In some embodiments, the performance information is aperiodically reported; and the aperiodic reporting is triggered by DCI.

In some embodiments, the first configuration for performance monitoring and/or the second configuration for performance information reporting are different from configuration for AI/ML reporting.

In some embodiments, the first configuration for performance monitoring and/or the second configuration for performance information reporting are the same as the configuration for AI/ML reporting.

In some embodiments, the first configuration for performance monitoring and/or the second configuration for performance information reporting are at least a part of the configuration for AI/ML reporting;

the AI/ML reporting includes at least one of the following: CSI reporting, beam reporting, or positioning information reporting.

In some embodiments, for different functionalities, the first configuration for performance monitoring and/or the second configuration for performance information reporting are different; or for different functionalities, the first configuration for performance monitoring and/or the second configuration for performance information reporting are the same.

In some embodiments, one first configuration for performance monitoring and/or one second configuration for performance information reporting are applied to one functionality, or one first configuration for performance monitoring and/or one second configuration for performance information reporting are applied to multiple functionalities.

In some embodiments, a manner for performance information reporting is different from a manner for AI/ML reporting, or the manner for performance information reporting is the same as the manner for AI/ML reporting; the manner includes periodic reporting, aperiodic reporting or semi-persistent reporting; the AI/ML reporting includes at least one of the following: CSI reporting, beam reporting, or positioning information reporting.

In some embodiments, for different functionalities, the manner for performance information reporting is different from the manner for AI/ML reporting, or for different functionalities, the manner for performance information reporting is the same as the manner for AI/ML reporting; the manner includes periodic reporting, aperiodic reporting or semi-persistent reporting; the AI/ML reporting includes at least one of the following: CSI reporting, beam reporting, or positioning information reporting.

In some embodiments, performance information is reported via MAC CE; the MAC CE includes performance information for one or more functionalities.

In some embodiments, the performance information is reported via PUCCH or MAC CE; the MAC CE includes performance information for one or more functionalities.

In some embodiments, the performance information is reported via an RRC message; the RRC message includes performance information for one or more functionalities.

In some embodiments, the performance information is periodically transmitted according to a timer and aperiodically transmitted based on a condition or event.

In some embodiments, the performance information is periodically transmitted according to the timer.

In some embodiments, the performance information is aperiodically transmitted based on the condition or event.

The embodiments above only schematically illustrate the present application, but the present application is not limited to this, and appropriate variations can also be made on the basis of the above embodiments. For example, the above embodiments may be used separately, or one or more of the above embodiments may be combined.

It is worth noting that only the components or modules related to the present application are illustrated hereinabove, but the present application is not limited to this. The apparatus for performance monitoring 800 may further include other components or modules, and the details of these components or modules can be seen by referring to the related art.

In addition, for the sake of simplicity, FIG. 8 only illustratively shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present application.

As can be seen from the above embodiments of the present application, the AI/ML model on the terminal equipment side is able to be monitored accurately, thereby improving the accuracy and reliability of AI/ML.

### Embodiments of a Fourth Aspect

The embodiments of the present application provide an apparatus for performance monitoring. The apparatus may be, for example, a network device, or one or more parts or components configured on the network device, and the same content as the embodiments of the first to third aspects will not be repeated.

FIG. 9 is a schematic diagram of an apparatus for performance monitoring in the embodiments of the present application. As shown in FIG. 9, an apparatus for performance monitoring 900 includes:

a transmitting unit 901 configured to transmit a first configuration to a terminal equipment; wherein the terminal equipment is configured to, based on the first configuration, monitor performance of an AI/ML model of which a functionality is enabled or activated, the functionality including a feature or a feature group enabled by a configuration indicated by capability of a terminal equipment; and

a receiving unit 902 configured to receive performance information corresponding to the functionality transmitted by the terminal equipment.

The embodiments above only schematically illustrate the present application, but the present application is not limited to this, and appropriate variations can also be made on the basis of the above embodiments. For example, the above embodiments may be used separately, or one or more of the above embodiments may be combined.

It is worth noting that only the components or modules related to the present application are illustrated hereinabove, but the present application is not limited to this. The apparatus for performance monitoring 900 may further include other components or modules, and the details of these components or modules can be seen by referring to the related art.

In addition, for the sake of simplicity, FIG. 8 only illustratively shows the connection relationship or signal trend between the individual components or modules, but it should be clear to those skilled in the art that various related techniques such as bus connections can be employed. The above individual components or modules can be implemented by hardware facilities such as a processor, a memory, a transmitter, a receiver, etc., which is not limited in the present application.

As can be seen from the above embodiments of the present application, the AI/ML model on the terminal equipment side is able to be monitored accurately, thereby improving the accuracy and reliability of AI/ML.

### Embodiments of a Fifth Aspect

The embodiments of the present application further provide a communication system, referring to FIG. 1, the same content as the embodiments in the first to fourth aspects will not be repeated.

In some embodiments, the communication system 100 may at least include:

a network device configured to transmit a first configuration to a terminal equipment;

the terminal equipment configured to, based on the first configuration, monitor performance of an AI/ML model of which a functionality is enabled or activated, the functionality including a feature or a feature group enabled by a configuration indicated by capability of a terminal equipment; and transmit performance information corresponding to the functionality to the network device.

The embodiments of the present application further provide a network device, which may be, for example, a base station, but which is not limited in the present application, and may also be other network devices.

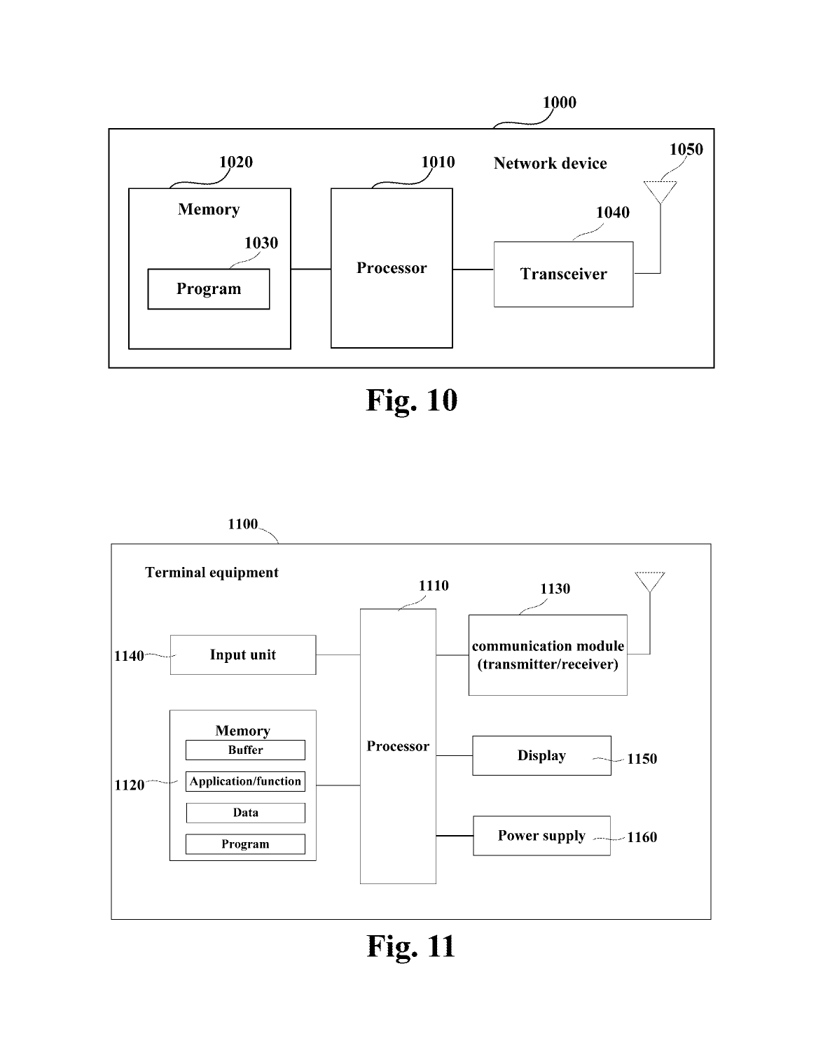

FIG. 10 is a schematic diagram of composition of the network device in the embodiments of the present application. As shown in FIG. 10, a network device 1000 may include a processor 1010 (such as a central processing unit (CPU)) and a memory 1020; the memory 1020 is coupled to the processor 1010. The memory 1020 may store various data and also may store a program 1030 for information processing, and the program 1030 is executed under the control of the processor 1010.

For example, the processor 1010 may be configured to execute the program to implement the method for performance monitoring as described in the embodiments of the second aspect. For example, the processor 1010 may be configured to perform the following controls of: transmitting a first configuration to a terminal equipment, wherein the terminal equipment is configured to, based on the first configuration, monitor performance of an AI/ML model of which a functionality is enabled or activated, the functionality including a feature or a feature group enabled by a configuration indicated by capability of a terminal equipment; and receiving performance information corresponding to the functionality transmitted by the terminal equipment.

In addition, as shown in FIG. 10, the network device 1000 may further include: a transceiver 1040 and an antenna 1050, etc., wherein the functionalitys of the above components are similar to the relevant art, and will not be repeated here. It is worth noting that the network device 1000 is not necessarily required to include all of the components shown in FIG. 10; in addition, the network device 1000 may further include components not shown in FIG. 10, with reference to the relevant art.

The embodiments of the present application further provide a terminal equipment, but which is not limited in the present application, and may also be other devices.

FIG. 11 is a schematic diagram of a terminal equipment in the embodiments of the present application. As shown in FIG. 11, a terminal equipment 1100 may include a processor 1110 and a memory 1120; the memory 1120 stores data and program, and is coupled to the processor 1110. It is worth noting that this figure is exemplary; other types of structures may also be used in addition to or instead of the structure to implement telecommunications functions or other functions.

For example, the processor 1110 may be configured to execute the program to implement the method for performance monitoring as described in the embodiments of the first aspect. For example, the processor 1110 may be configured to perform the following controls of: receiving a first configuration transmitted by a network device; based on the first configuration, monitoring performance of an AI/ML model of which a functionality is enabled or activated, the functionality including a feature or a feature group enabled by a configuration indicated by capability of a terminal equipment; and transmitting performance information corresponding to the functionality to the network device.

As shown in FIG. 11, the terminal equipment 1100 may further include a communication module 1130, an input unit 1140, a display 1150, and a power supply 1160. The functions of the above components are similar to the relevant art, and will not be repeated here. It is worth noting that the terminal equipment 1100 is not necessarily required to include all of the components shown in FIG. 11, and the above components are not essential; in addition, the terminal equipment 1100 may further include components not shown in FIG. 11, with reference to the relevant art.

The embodiments of the present application further provide a computer program which, when being executed in the terminal equipment, causes the terminal equipment to execute the method for performance monitoring described in the embodiments of the first aspect.

The embodiments of the present application further provide a storage medium storing a computer program which causes the terminal equipment to execute the method for performance monitoring described in the embodiments of the first aspect.

The embodiments of the present application further provide a computer program which, when being executed in the network device, causes the network device to execute the method for performance monitoring described in the embodiments of the second aspect.

The embodiments of the present application further provide a storage medium storing a computer program which causes the network device to execute the method for performance monitoring described in the embodiments of the second aspect.

The above apparatuses and methods of the present application can be implemented by hardware or by hardware combined with software. The present application relates to a computer readable program which, when being executed by a logic unit, enables the logic unit to implement the apparatuses or components mentioned above, or enables the logic unit to implement the methods or steps described above. The present application also relates to storage medium for storing the above programs, such as a hard disk, a magnetic disk, a compact disc, a DVD, a flash memory, etc.

The method/apparatus described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules can be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium can be coupled to a processor so that the processor can read information from the storage medium and write information to the storage medium; or the storage medium can be a constituent part of the processor. The processor and the storage medium can be located in the ASIC. The software module can be stored in the memory of the mobile terminal or in a memory card that can be inserted into the mobile terminal. For example, if a device (such as a mobile terminal) uses a large-capacity MEGA-SIM card or a large-capacity flash memory device, the software module can be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

For implementation including the above embodiments, the following supplements are further disclosed:

1. A method for performance monitoring, including:

receiving, by a terminal equipment, a first configuration transmitted by a network device;

according to the first configuration, monitoring performance of an AI/ML model of which a functionality is enabled or activated, the functionality including a feature or a feature group enabled by a configuration indicated by capability of a terminal equipment; and

transmitting performance information corresponding to the functionality to the network device.

2. A method for performance monitoring, including:

transmitting, by a network device, a first configuration to a terminal equipment; wherein the terminal equipment is configured to, based on the first configuration, monitor performance of an AI/ML model of which a functionality is enabled or activated, the functionality including a feature or a feature group enabled by a configuration indicated by capability of a terminal equipment; and

receiving performance information corresponding to the functionality transmitted by the terminal equipment.

3. A terminal equipment including a memory storing a computer program and a processor configured to execute the computer program to implement the method for performance monitoring according to the supplement 1.

4. A network device including a memory storing a computer program and a processor configured to execute the computer program to implement the method for performance monitoring according to the supplement 2.

1. An apparatus for performance monitoring, comprising:
a receiver configured to receive a first configuration and a second configuration transmitted by a network device; wherein the first configuration at least comprises one or more performance metrics and the second configuration at least comprises a reporting configuration;
processor circuitry configured to, according to the first configuration, monitor performance of a functionality of AI/ML (Artificial Intelligence/Machine Learning); and
a transmitter configured to transmit performance information corresponding to the functionality to the network device according to the reporting configuration.

2. The apparatus according to claim 1, wherein the functionality is located on a terminal equipment side and comprises a feature or a feature group enabled by configuration indicated by capability of a terminal equipment, and the first configuration comprises at least one of the following: a parameter for controlling monitoring, or a reference signal configuration.

3. The apparatus according to claim 1, wherein the second configuration comprises at least one of the following: an uplink resource for transmitting the performance information, or a manner for reporting the performance information; the manner comprises periodic reporting, semi-persistent reporting, or aperiodic reporting; the performance information comprises at least one of the following: a performance metric, input data drift, or output data drift.

4. The apparatus according to claim 1, wherein the functionality is one or more, the terminal equipment is configured to perform AI/ML performance monitoring for each functionality separately, and the network device is configured to determine whether the functionality fails or whether the functionalityis deactivated according to the performance information.

5. The apparatus according to claim 1, wherein the receiver is configured to receive a reference signal for AI/ML performance monitoring, transmitted by the network device; wherein the reference signal for the AI/ML performance monitoring is periodic and/or semi-persistent;
the processor circuitry is configured to monitor the AI/ML performance corresponding to the functionality according to the reference signal and to calculate the performance information.

6. The apparatus according to claim 5, wherein the receiver is further configured to receive response information fed back from the network device according to indication information, the response information comprising at least one of the following: functionality activation information, functionality deactivation information, functionality fallback information, functionality switching information or reconfiguration information.

7. The apparatus according to claim 5, wherein the reference signal for the AI/ML performance monitoring is different from a reference signal for measurement or inference.

8. The apparatus according to claim 5, wherein the performance information transmitted by the terminal equipment to the network device is for one or more functionalities.

9. The apparatus according to claim 5, wherein the performance information is periodically reported; a periodic reference signal is configured for performing monitoring, and an uplink resource is configured for performing reporting of the performance information; or the performance information is reported by using two-step random access.

10. The apparatus according to claim 5, wherein the performance information is semi-persistently reported; a periodic or a semi-persistent reference signal is configured for performing monitoring, and an uplink resource is configured for performing reporting of the performance information; and a semi-persistent reporting is activated/deactivated by a MAC (media access control) CE (control element) or DCI (downlink control information).

11. The apparatus according to claim 5, wherein the performance information is aperiodically reported; and an aperiodic reporting is triggered by DCI.

12. The apparatus according to claim 1, wherein the first configuration for performance monitoring and/or the second configuration for performance information reporting are/is different from a configuration for AI/ML reporting; or
the first configuration for performance monitoring and/or the second configuration for performance information reporting are/is the same as a configuration for AI/ML reporting; or
the first configuration for performance monitoring and/or the second configuration for performance information reporting are/is at least a part of a configuration for AI/ML reporting;
the AI/ML reporting comprises at least one of the following: CSI (channel state information) reporting, beam reporting, or positioning information reporting.

13. The apparatus according to claim 1, wherein for different functionalities, the first configuration for performance monitoring and/or the second configuration for performance information reporting are/is different; or for different functionalities, the first configuration for performance monitoring and/or the second configuration for performance information reporting are/is the same;
one first configuration for performance monitoring and/or one second configuration for performance information reporting are/is applied to one functionality, or one first configuration for performance monitoring and/or one second configuration for performance information reporting are/is applied to multiple functionalities.

14. The apparatus according to claim 1, wherein a manner for performance information reporting is different from a manner for AI/ML reporting, or a manner for performance information reporting is the same as the manner for AI/ML reporting;
the manner comprises periodic reporting, aperiodic reporting or semi-persistent reporting; the AI/ML reporting comprises at least one of the following: CSI reporting, beam reporting, or positioning information reporting.

15. The apparatus according to claim 1, wherein for different functionalities, a manner for performance information reporting is different from a manner for AI/ML reporting, or for different functionalities, a manner for performance information reporting is the same as a manner for AI/ML reporting;
the manner comprises periodic reporting, aperiodic reporting or semi-persistent reporting; the AI/ML reporting comprises at least one of the following: CSI reporting, beam reporting, or positioning information reporting.

16. The apparatus according to claim 1, wherein the performance information is reported via a MAC CE; the MAC CE comprises performance information for one or more functionalities; or
the performance information is reported via a PUCCH (physical uplink control channel) or a MAC CE; the MAC CE comprises performance information for one or more functionalities; or
the performance information is reported via an RRC (radio resource control) message; the RRC message comprises performance information for one or more functionalities.

17. The apparatus according to claim 16, wherein the performance information is periodically transmitted according to a timer and aperiodically transmitted according to a condition or event; or
the performance information is periodically transmitted according to a timer; or
the performance information is aperiodically transmitted according to a condition or event.

18. An apparatus for performance monitoring, comprising:
a transmitter configured to transmit a first configuration and a second configuration to a terminal equipment, the first configuration at least comprising one or more performance metrics and the second configuration at least comprising a reporting configuration; and
a receiver configured to receive performance information corresponding to a functionality of AI/ML from the terminal equipment according to the reporting configuration, the performance information being obtained by monitoring performance of the functionality.

19. A communication system, comprising:
a network device configured to transmit a first configuration and a second configuration, the first configuration at least comprising one or more performance metrics and the second configuration at least comprising a reporting configuration; and
a terminal equipment configured to:
monitor, according to the first configuration, performance of a functionality of AI/ML; and
transmit performance information corresponding to the functionality to the network device according to the reporting configuration.
